(19) United States
(12) Patent Application Publication
(10) Pub. No.: US 2025/0140008 A1
(43) Pub. Date: May 1, 2025

(54) IMAGE PROCESSING APPARATUS, IMAGE PROCESSING METHOD, AND NON-TRANSITORY RECORDING MEDIUM

(71) Applicant: Noriko Miyagi, KANAGAWA (JP)

(72) Inventor: Noriko Miyagi, KANAGAWA (JP)

(73) Assignee: Ricoh Company, Ltd., Tokyo (JP)

(21) Appl. No.: 18/931,759

(22) Filed: Oct. 30, 2024

(30) Foreign Application Priority Data
Nov. 1, 2023 (JP) 2023-187949
Jun. 11, 2024 (JP) 2024-094285

(51) Int. Cl. G06V 30/148; G06V 30/414

(52) U.S. Cl. CPC G06V 30/148; G06V 30/414

(57) ABSTRACT

An image processing apparatus includes a scanner to read a document and generate first image data of the document and circuitry. The circuitry detects a digit separator line, which is a vertical ruled line that divides a numerical value by one digit or three digits, in the first image data separately from another ruled line, and removes the digit separator line from the first image data.

### CROSS-REFERENCE TO RELATED APPLICATIONS

This patent application is based on and claims priority pursuant to 35 U.S.C. § 119 (a) to Japanese Patent Application Nos. 2023-187949, filed on Nov. 1, 2023, and 2024-094285, filed on Jun. 11, 2024, in the Japan Patent Office, the entire disclosure of which is hereby incorporated by reference herein.

### BACKGROUND

### Technical Field

Embodiments of the present disclosure relate to an image processing apparatus, an image processing method, and a non-transitory recording medium.

### Related Art

Technologies to improve the efficiency of correcting optical character recognition (OCR) results by an operator are known. For example, related art includes converting all or a part of a character frame extracted from input image data into a matching-purpose character frame having a different color or deleting that part, and displaying on a monitor the result after the conversion or deletion.

### SUMMARY

In one embodiment, an image processing apparatus includes a scanner to read a document and generate first image data of the document and circuitry. The circuitry detects a digit separator line in the first image data separately from another ruled line, and removes the digit separator line from the first image data. The digit separator line is a vertical ruled line that divides a numerical value by one digit or three digits.

In another embodiment, an image processing method includes reading a document to generate first image data of the document, detecting a digit separator line in the first image data separately from another ruled line, and removing the digit separator line from the first image data. The digit separator line is a vertical ruled line that divides a numerical value by one digit or three digits.

In another embodiment, a non-transitory recording medium stores a plurality of program codes which, when executed by one or more processors, causes the one or more processors to perform the method described above.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1A is a diagram illustrating an example of an image processing apparatus;

FIGS. 1B and 1C are diagrams each illustrating an image processing system according to one embodiment;

FIG. 2 is a schematic block diagram illustrating an example of a hardware configuration of the image forming apparatus illustrated in FIG. 1;

FIG. 3 is a block diagram illustrating an example of a functional configuration for removing digit separator lines of the image forming apparatus;

FIG. 4 is a diagram of image examples illustrating functions provided by the functional configuration for removing digit separator lines illustrated in FIG. 3;

FIG. 5 is a diagram illustrating examples of functional units to perform a sequence of image processing inside a column detection unit;

FIGS. 6A to 6F are diagrams of image examples illustrating the sequence of image processing inside the column detection unit illustrated in FIG. 5;

FIG. 7 is a diagram illustrating an example of a configuration of a learning device for generating a learned model of an inference unit;

FIG. 8 is a diagram illustrating training data acquired by an obtaining unit of the learning device illustrated in FIG. 7;

FIGS. 9A and 9B are diagrams illustrating digit separator lines;

FIG. 10 is a flowchart of an image processing process performed by the image forming apparatus according to one embodiment; and

FIG. 11 is a flowchart of a subroutine process performed by the column detection unit in a step of FIG. 10.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise. In order to facilitate the understanding of the description, like components are denoted by like reference signs throughout the drawings, and redundant descriptions may be omitted.

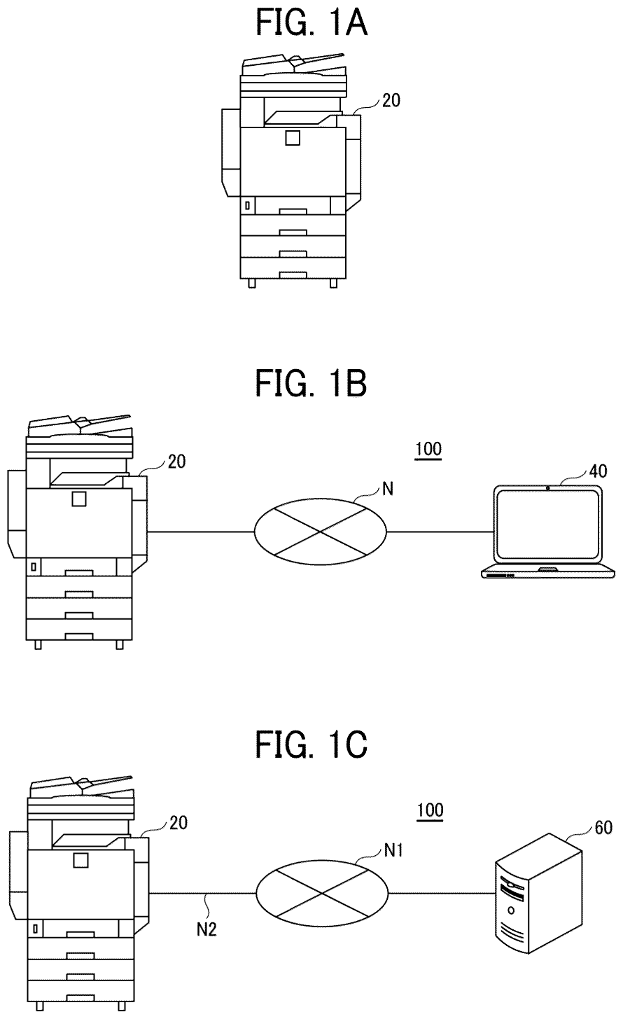

FIGS. 1A, 1B, and 1C are diagrams each illustrating an example of an image processing apparatus or an image processing system according to an embodiment of the present disclosure.

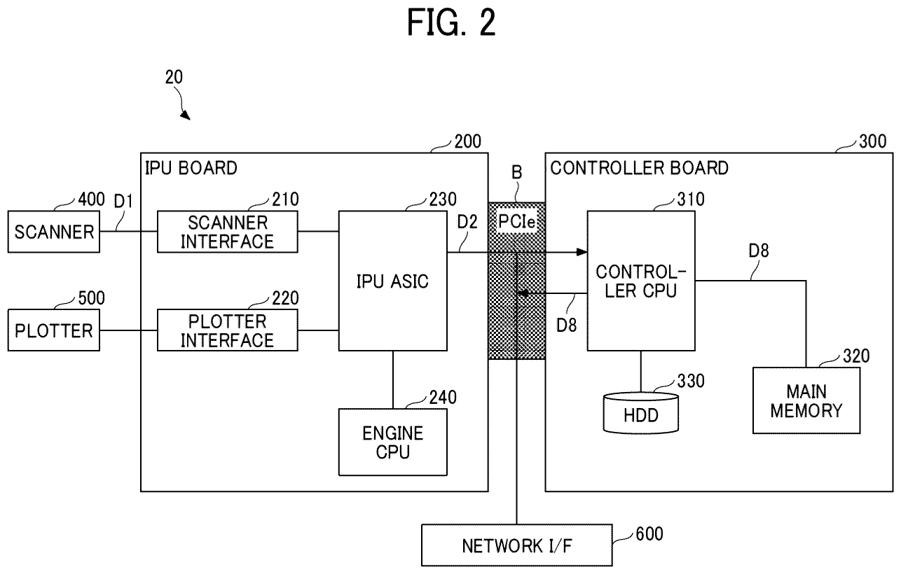

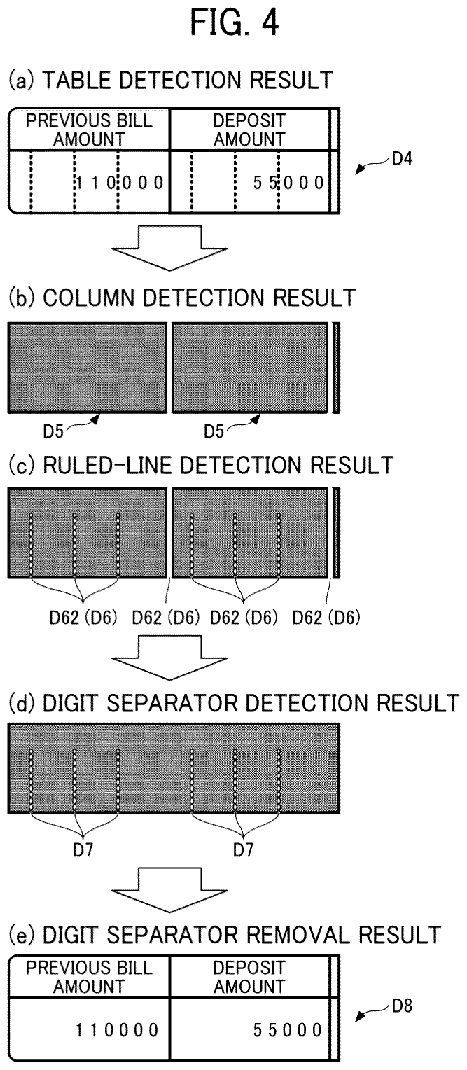

FIG. 1 a illustrates an image forming apparatus 20 as an image processing apparatus that removes digit separator lines. The image forming apparatus 20 is called a multifunction printer or multifunction peripheral (MFP) having multiple functions. The image forming apparatus 20 has multiple functions including a scanning function. The image forming apparatus 20 can read a document by a scanner 400 (see FIG. 2), convert the read data into electronic image data (input image data D1, first image data) for communication or storing, perform various image processing including the removal of digit separator lines (may be referred to as “digit-separator line removal”), and transmit the processed image data (digit-separator-removed image data D8, second image data) to, for example, a personal computer (PC). The input image data D1, the digit-separator-removed image data D8, and image data D2 to D7 in the intermediate process will be described later with reference to FIG. 4.

The term “document” used in the present embodiment refers to a medium on which characters are recorded. Example of the document include business form paper. The “medium” includes, for example, a film other than paper. The “character” includes, for example, a number such as an amount of money. In the present embodiment, a business form is exemplified as the “document,” but the “document” includes other documents on which an amount of money is recorded, such as a household account book.

FIG. 1B illustrates an image processing system 100 in which the image forming apparatus 20 and a PC 40 communicate with each other via a network N. In the image processing system 100 illustrated in FIG. 1B, the digit-separator-removed image data D8, which is obtained by the image forming apparatus 20 performing various image processing including the digit-separator line removal on the input image data D1, can be transmitted to the PC 40 via the network N.

FIG. 1C illustrates another image processing system 100 in which the image forming apparatus 20 and a storage device 60 communicate with each other via networks N1 and N2. In the image processing system 100 illustrated in FIG. 1C, the digit-separator-removed image data D8, which is obtained by the image forming apparatus 20 performing various image processing including the digit-separator line removal on the input image data D1, can be transmitted to the storage device 60 via the networks N1 and N2.

FIG. 2 is a schematic block diagram illustrating an example of a hardware configuration of the image forming apparatus 20. The image forming apparatus 20 includes an image processing unit (IPU) board 200, a controller board 300, the scanner 400, a plotter 500, and a network interface (I/F) 600.

The IPU board 200 and the controller board 300 are connected to each other via a PCIe (PCI Express) bus B.

The IPU board 200 includes a scanner interface 210, a plotter interface 220, an IPU application-specific integrated circuit (ASIC) 230, and an engine central processing unit (CPU) 240. The scanner interface 210 is connected between the scanner 400 and the IPU ASIC 230. The plotter interface 220 is connected between the plotter 500 and the IPU ASIC 230. The engine CPU 240 is connected to the IPU ASIC 230.

The controller board 300 includes a controller CPU 310, a main memory 320, and a hard disk drive (HDD) 330. The main memory 320 and the HDD 330 are connected to the controller CPU 310.

The IPU ASIC 230 of the IPU board 200 and the controller CPU 310 of the controller board 300 are connected to each other via the PCIe bus B. The network I/F 600 is connected to the IPU ASIC 230 and the controller CPU 310 via the PCIe bus B.

The scanning function of the image forming apparatus 20 is described. The input image data D1 (first image data) obtained by the scanner 400 (an image reader) is transmitted to the IPU ASIC 230 via the scanner interface 210 of the IPU board 200, and the IPU ASIC 230 performs image processing to correct image deterioration (such as top-bottom orientation correction and skew correction) caused, for example, at the time of scanning. In the following description, the image after the image processing may be referred to as “corrected image data D2.” The corrected image data D2 is transmitted to the controller CPU 310 of the controller board 300 via the PCIe bus B, and optional or additional image processing (e.g., OCR processing and digit-separator line removal) is performed. The digit-separator-removed image data D8 after the image processing by the controller CPU 310 is transmitted to the outside via the network I/F 600. The digit-separator-removed image data D8 may be stored in the main memory 320 and then returned to the controller CPU 310 and transmitted to the outside via the network I/F 600.

In the present embodiment, the digit-separator line removal is performed by the controller CPU 310 as one of the image processing in the scan function.

The digit-separator line removal is switchable between on and off. Turning the digit-separator line removal function “on” means setting the apparatus to execute the digit-separator line removal. Turning the digit-separator line removal function off means setting the apparatus not to execute the digit-separator line removal. In other words, “switching on and off” means switching of whether to execute the digit-separator line removal. In some cases, the amounts of money written in business forms overlap the digit separator lines, and a part of the characters representing the amount of money in the input image data D1 read by the scanner 400 is lost when the digit separator lines are removed. In that case, the digit-separator line removal is turned off to prevent the loss of the characters representing the amount of money in the input image data D1.

The turning on and off the digit-separator line removal can be performed by the user of the image forming apparatus 20 via, for example, a control panel such as a touch panel of the image forming apparatus 20.

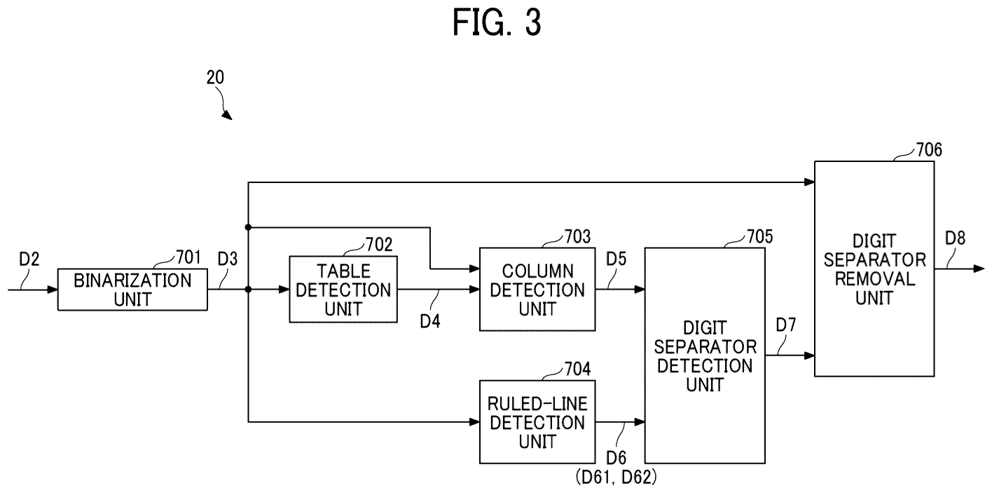

FIG. 3 is a block diagram illustrating an example of a functional configuration for removing digit separator lines of the image forming apparatus 20. As illustrated in FIG. 3, the image forming apparatus 20 includes a binarization unit 701, a table detection unit 702, a column detection unit 703, a ruled-line detection unit 704, a digit separator detection unit 705, and a digit separator removal unit 706 for removing digit separator lines from the input image data D1 read by the scanner 400. The functions of these units are implemented by the controller CPU 310 illustrated in FIG. 2.

The binarization unit 701 converts the input image from a red-green-blue (RGB) image to a grayscale image and further converts the grayscale image to binary image data D3 by discriminant analysis binarization. The image data input to the binarization unit 701 is the corrected image data D2 obtained by performing various image processing such as top-bottom orientation correction and skew processing on the input image data D1 read by the scanner 400. In FIG. 3, the input image data D1 and the image processing preceding the corrected image data D2 are omitted.

Even after the various image processing is performed on the input image data D1, it is possible that the input image data D1 does not include any elements that need to be corrected, and the difference by correction does not arise. In this case, the corrected image data D2 may be identical to the input image data D1.

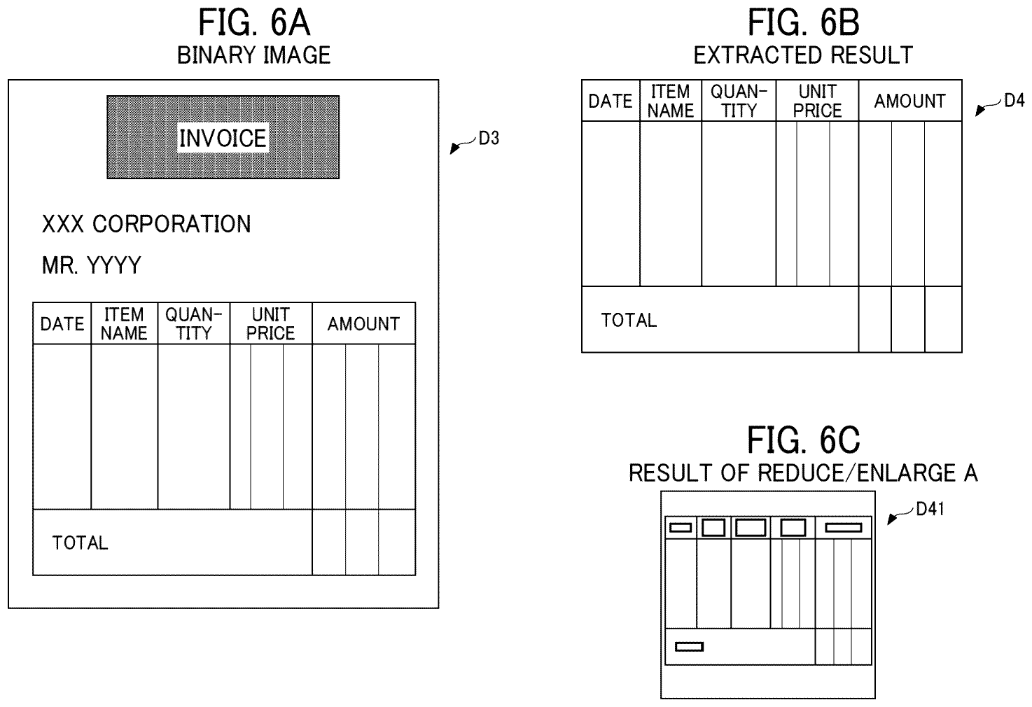

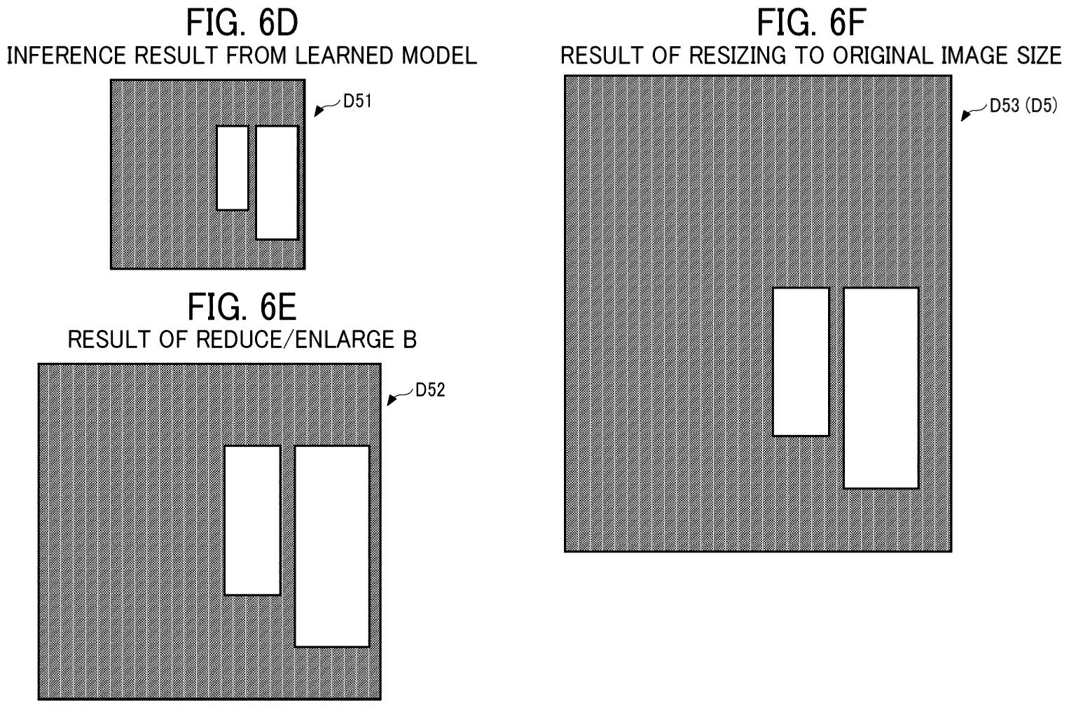

The following description exemplifies an invoice as a document to be processed. In this case, the input image data D1, the corrected image data D2, and the binary image data D3 are data including the entire invoice (see FIG. 6A).

The binarization method in the binarization unit 701 may be another method such as binarization using a fixed threshold value. To reduce the amount of data transmission through the PCIe bus B, the IPU ASIC 230 may perform the binarization instead of the binarization unit 701, and the controller CPU 310 may perform the processing performed by the table detection unit 702 and the subsequent processing. The binarization unit 701 outputs information of the converted binary image data D3 to the table detection unit 702, the column detection unit 703, the ruled-line detection unit 704, and the digit separator removal unit 706.

The table detection unit 702 recognizes, for example, a region including a black run having a predetermined length or longer as a table region from the binary image data D3, and outputs table image data D4 including the coordinate information of the circumscribed rectangle of the table region. A “black run” is a continuous portion of black pixels obtained by scanning a binary image in the main scanning direction (horizontal direction) and the sub-scanning direction (vertical direction). Table regions are recognized by, for example, the method described in Japanese Unexamined Patent Application Publication No. 2000-082110.

When the document to be processed is an invoice, the “table region” is, out of the entire invoice, a table that contains billing details such as product name, quantity, unit price, amount of money for each item, and total amount of money. The table image data D4 is data including such a table portion (see FIGS. 4(a) and 6B). The table image data D4 also includes coordinate information indicating the position of the table in the binary image data D3. The table detection unit 702 outputs the table image data D4 detected from the binary image data D3 to the column detection unit 703.

The column detection unit 703 receives the binary image data D3 converted by the binarization unit 701 and the table image data D4 detected from the binary image data D3 by the table detection unit 702, and detects a column region in the table image data D4 using a learned model. The column detection unit 703 outputs column image data D5 including coordinate information of the circumscribed rectangle of the detected column region.

The “column region” is a group of columns containing amounts of money out of the above-described table region.

The column image data D5 illustrated in FIG. 4(b) is data including such a group of columns. When the table region includes items related to multiple amounts of money (for example, unit price and amount billed for each item), the column region is divided for each item as illustrated in, for example, FIGS. 4(b), 6F, and 8. The column image data D5 also includes coordinate information indicating the position of the group of columns in the binary image data D3 or the table image data D4.

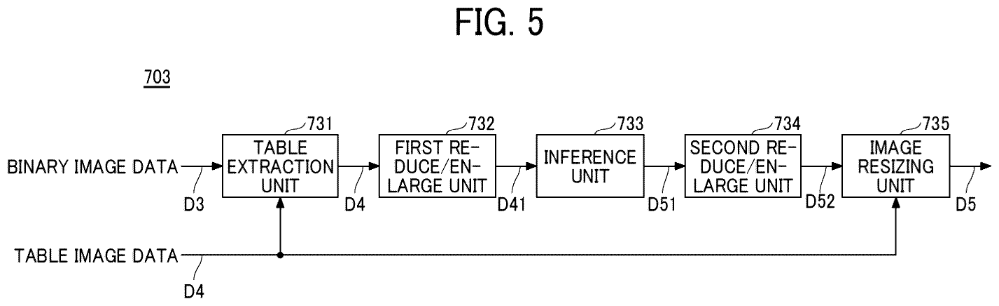

An example of the method for detecting a column region using a learned model will be described later with reference to FIG. 5. The column detection unit 703 outputs the column image data D5 detected from the table image data D4 to the digit separator detection unit 705.

The ruled-line detection unit 704 extracts black runs of a predetermined value or more from, for example, the binary image data D3 converted by the binarization unit 701. The ruled-line detection unit 704 then recognizes and extracts connected components of the black runs as ruled lines. In the ruled line extraction process, scanning is performed in both the main scanning direction and the sub-scanning direction to extract the ruled lines in the main scanning direction (horizontal ruled lines) and the ruled lines in the sub-scanning direction (vertical ruled lines). The ruled-line detection unit 704 outputs the ruled-line image data D6 including the coordinate information of the detected ruled lines. The ruled-line image data D6 includes horizontal ruled-line image data D61 and vertical ruled-line image data D62 (see FIG. 3).

In a document to be processed is an invoice, the “horizontal ruled line” is a line segment extending in the horizontal direction in the table of the invoice, and the “vertical ruled line” is a line segment extending in the vertical direction in the table of the invoice. The horizontal ruled-line image data D61 and the vertical ruled-line image data D62 include horizontal ruled-line regions and vertical ruled-line regions as illustrated in FIG. 4(c). The horizontal ruled-line image data D61 and the vertical ruled-line image data D62 also include coordinate information indicating the position of the ruled lines in the binary image data D3 or the table image data D4. Rules lines are recognized by, for example, the method described in Japanese Unexamined Patent Application Publication No. 2000-082110. The ruled-line detection unit 704 outputs the ruled-line image data D6 (the horizontal ruled-line image data D61 and the vertical ruled-line image data D62) detected from the binary image data D3 to the digit separator detection unit 705.

The digit separator detection unit 705 recognizes and detects, as digit separator lines, the regions detected as the column image data D5 by the column detection unit 703 and detected as the vertical ruled-line image data D62 by the ruled-line detection unit 704. The digit separator detection unit 705 outputs digit separator line image data D7 including the coordinate information of the detected digit separator lines to the digit separator removal unit 706.

In a document to be processed is an invoice, the “digit separator line” is a digit separator line separating a numeral value representing an amount in the column region of the invoice. The digit separator line image data D7 includes such a digit separator line region as illustrated in FIG. 4(d). The digit separator line image data D7 also includes coordinate information indicating the position of the digit separator line in the binary image data D3 or the table image data D4.

The digit separator removal unit 706 replaces the pixel data (black pixels) in the binary image data D3 corresponding to the digit separator line image data D7 detected by the digit separator detection unit 705 with white pixels. The digit separator removal unit 706 performs image processing for removing the digit separator line from the corrected image data D2 (or the input image data D1) input to, for example, the binarization unit 701 based on the processing result, and outputs the digit-separator-removed image data D8 from which the digit separator lines are removed.

As illustrated in FIG. 3, in the present embodiment, instead of directly detecting digit separator lines from the table image data D4 extracted by the table detection unit 702, the detection of digit separator lines involves detecting ruled lines in the column image data D5 via the column detection unit 703. Such a procedure is performed to keep the learned model generated by machine learning lightweight while increasing the accuracy of detection of various table regions and digit separator lines using machine learning. This is because the column detection unit 703 can accurately detect column regions even in a low-resolution image, and the learned model for the column detection unit 703 can be lightweight.

FIG. 4 is a diagram of image examples illustrating the functions provided by the functional configuration for removing digit separator lines illustrated in FIG. 3.

For example, the binary image data D3 converted by the binarization unit 701 from the input image data D1 read by the scanner 400 includes the table image data D4 illustrated in FIG. 4(a), and the table detection unit 702 recognizes the table image data D4 as a table region.

FIG. 4(b) illustrates the detection result by the column detection unit 703 of the table image data D4 detected by the table detection unit 702. In FIG. 4(b), the regions detected as the column image data D5 in the table image data D4 are indicated by hatching.

FIG. 4(c) illustrates the detection result by the ruled-line detection unit 704 of the table image data D4 detected by the table detection unit 702. The regions extracted as the vertical ruled-line image data D62 in the table image data D4 is indicated by white.

In FIG. 4(d), the regions that are hatched in FIG. 4(b) and indicated in white in FIG. 4(c), that is, common regions between the table image data D4 and the vertical ruled-line image data D62, are indicated in white. The white regions are detected as the digit separator line image data D7 by the digit separator detection unit 705.

In FIG. 4(e), the digit separator removal unit 706 replaces, with white pixels, the pixels in the table image data D4 (binary image data D3) of FIG. 4(a) corresponding to the digit separator line image data D7 detected in FIG. 4(d), thereby outputting the digit-separator-removed image data D8 obtained by removing the digit separator lines from the input image data D1.

FIG. 5 is a functional block diagram illustrating details of the column detection unit 703. As illustrated in FIG. 5, the column detection unit 703 includes a table extraction unit 731, a first reduce/enlarge unit 732, an inference unit 733, a second reduce/enlarge unit 734, and an image resizing unit 735.

The table extraction unit 731 receives the binary image data D3 output from the binarization unit 701 and the table image data D4 output from the table detection unit 702 and extracts a table region in the binary image data D3 based on coordinate information of the table region included in the table image data D4. The table extraction unit 731 outputs the table image data D4 extracted from the binary image data D3 to the first reduce/enlarge unit 732. The column detection unit 703 may be configured to directly input the table image data D4 received from the table detection unit 702 to the first reduce/enlarge unit 732 without including the table extraction unit 731.

The first reduce/enlarge unit 732 scales the table image data D4 extracted by the table extraction unit 731 to a desired image size (for example, 256 pixels×256 pixels) by, for example, a bicubic method. Since basically reduction is performed in this process, it is desirable to apply a scaling method that does not break characters or lines due to the reduction. The first reduce/enlarge unit 732 outputs the scaled table image data D41 to the inference unit 733.

The inference unit 733 inputs the scaled table image data D41, which is extracted by the table extraction unit 731 and scaled by the first reduce/enlarge unit 732, to the learned model generated by machine learning and stored in advance and infers a column region. The inference unit 733 generates inferred column image data D51 in which the column region is specified in the scaled table image data D41 based on the output from the learned model, and outputs the inferred column image data D51 to the second reduce/enlarge unit.

The second reduce/enlarge unit 734 scales the inferred column image data D51 received from the inference unit 733 by a nearest neighbor method. The magnification/reduction ratio in this scaling is the reciprocal of the magnification/reduction ratio applied by the first reduce/enlarge unit 732. The magnification/reduction in this process is basically enlargement. The second reduce/enlarge unit 734 outputs inferred column image data D52 after scaling to the image resizing unit 735.

The image resizing unit 735 converts the inferred column image data D52 after scaling from the second reduce/enlarge unit 734 into inference result image data D53 of the column region. The inference result image data D53 has the size matching the size of the binary image data D3 input to the column detection unit 703. Specifically, the inference result image data D53 (all pixels, a pixel value representing non-column region is set to inferred column region) of the same size as the binary image data D3 is generated. The image resizing unit 735 outputs the inference result image data D53 as the final column image data D5.

One reason for the conversion into the binary image data D3 by the binarization unit 701 is pre-processing of the process by, for example, the table detection unit 702, other than the column detection unit 703 in FIG. 3 but the conversion into the binary image data D3 has effects on the column detection unit 703. When the first reduce/enlarge unit 732 performs scaling by, for example, the bicubic method, the binary image data D3 is converted into monochrome multi-valued image (grayscale image), and the converted image is input to the learned model of the inference unit 733. In general, when the image forming apparatus 20 performs inference using a learned model, reduction in weight of the model is an issue. It is preferable that the learned model used in the inference unit 733 of the present embodiment be lightweight (the number of parameters and the amount of calculation are minimized) while maintaining accuracy. Configuring the apparatus such that monochrome image data (the scaled table image data D41) instead of the RGB image is input to the model can make the model lightweight while maintaining the accuracy.

FIGS. 6A to 6F are diagrams illustrating a sequence of image processing inside the column detection unit 703 illustrated in FIG. 5 by using image examples.

For example, assume that the binary image data D3 illustrated in FIG. 6A is input to the column detection unit 703 together with the table image data D4 output from the table detection unit 702.

FIG. 6B illustrates the table image data D4 output from the table extraction unit 731. For example, the area indicated by the coordinate information of the table region included in the table image data D4 is extracted from the binary image data D3 of FIG. 6A.

FIG. 6C illustrates the scaled table image data D41 output from the first reduce/enlarge unit 732. The scaled table image data D41 is a result of reduction (scaling A) on the table image data D4 in FIG. 6B so as to have a desired image size.

FIG. 6D illustrates the inferred column image data D51 output from the inference unit 733. The white portion in FIG. 6D is the area inferred as the column region in the scaled table image data D41 by the learned model of the inference unit 733.

FIG. 6E illustrates the inferred column image data D52 after scaling, output from the second reduce/enlarge unit 734, and illustrates a result of enlargement (scaling B) to restore the size before the reduction by the first reduce/enlarge unit 732.

FIG. 6F illustrates the inference result image data D53 output from the image resizing unit 735, that is, the column image data D5. In FIG. 6F, the inference result of the column region is reflected in the image data converted into the original image size, that is, the same size as the binary image data D3 illustrated in FIG. 6A. The white portion in FIG. 6F corresponds to the region of the column image indicated by hatching in FIG. 4(b).

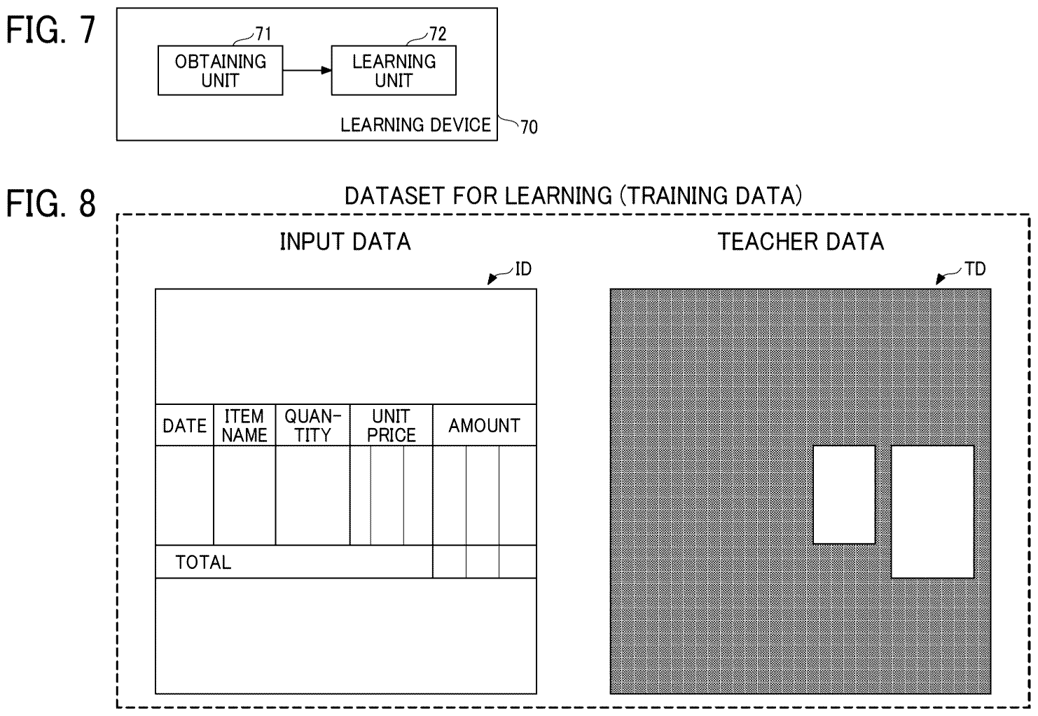

FIG. 7 is a diagram illustrating an example of the configuration of a learning device 70 that generates a learned model of the inference unit 733 in advance by machine learning. The learning device 70 includes an obtaining unit 71 that obtains training data used for the learning and a learning unit 72 that performs machine learning based on the training data.

The obtaining unit 71 is, for example, a communication interface that obtains training data from another device. Alternatively, the obtaining unit 71 may obtain training data held by the learning device 70. For example, the learning device 70 includes a storage unit, and the obtaining unit 71 is an interface that reads training data from the storage unit. The learning in the present embodiment is supervised learning. The training data in supervised learning is a dataset in which input data and teacher data (labeled data) are associated with each other.

The learning unit 72 performs machine learning based on the training data obtained by the obtaining unit 71 and generates a learned model. The learning unit 72 includes a memory that stores information and a processor that operates based on the information stored in the memory. As the processor, various kinds of processors such as a CPU, a graphics processing unit (GPU), and a digital signal processor (DSP) can be used. The memory may be a semiconductor memory such as a static random-access memory (SRAM) or a dynamic RAM (DRAM), a register, a magnetic storage device such as a hard disk device, or an optical storage device such as an optical disc device. For example, the memory stores commands for instructing the hardware circuit of the processor to operate. The function of each unit of the learning device 70 is implemented by the processor executing the commands.

FIG. 8 is a diagram illustrating training data obtained by the obtaining unit 71 of the learning device 70 illustrated in FIG. 7. The training data is a dataset including a sufficient number (generally, several tens of thousands) of sets of input data ID and corresponding teacher data TD for learning. In the present embodiment, training data for machine learning is used to allow the column detection unit 703 to infer a column region. Data used as the input data ID of the training data is the table image data scaled into the same size as the output of the first reduce/enlarge unit 732 by the scaling method same as the method used by the first reduce/enlarge unit 732. In other words, the input image ID is like the scaled table image data D41 described with reference to FIGS. 5 and 6C.

Data used as the teacher data TD of the training data is image data to which the region corresponding to the column region of the input data ID is extracted. In FIG. 8, the region corresponding to the outline of the input data ID is in black, and the region corresponding to the column regions are in white. The teacher data TD is generated such that column regions are detected with digit separator lines in the columns ignored. The teacher data TD is similar to the inferred column image data D51 described with reference to FIGS. 5 and 6D. The learning unit 72 performs machine learning using such training data.

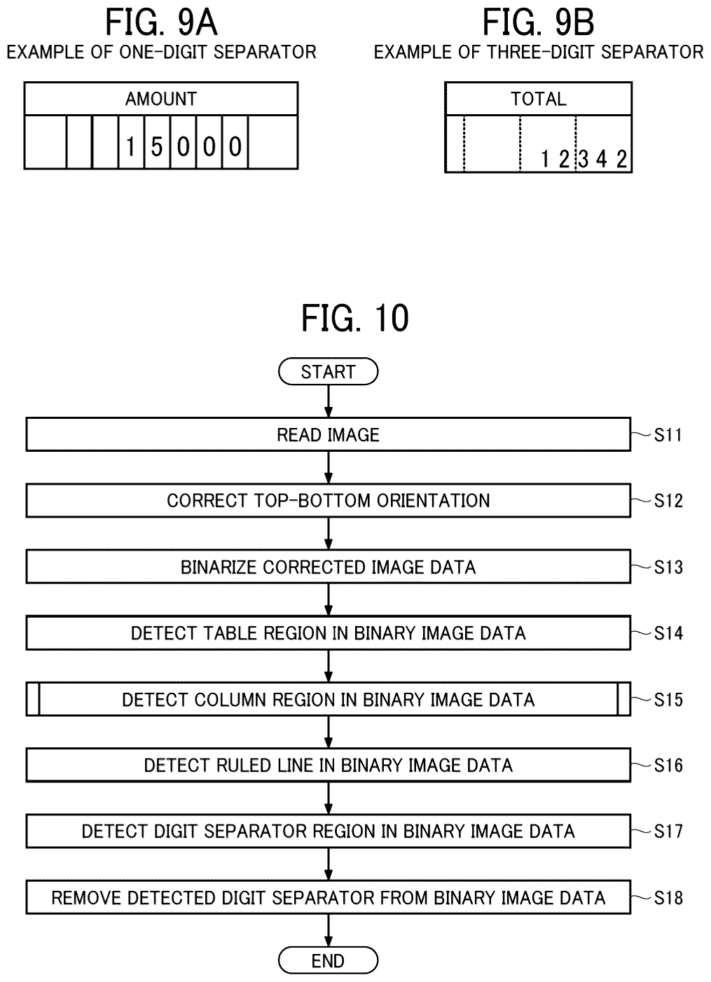

FIGS. 9A and 9B are diagrams each illustrating digit separator lines. FIG. 9A illustrates an example of digit separator lines for one-digit separation. FIG. 9B illustrates an example of digit separator lines for three-digit separation. Both the digit separator lines are the target of the digit-separator line removal of the present embodiment. The digit separator lines may be solid lines or broken lines.

The image forming apparatus 20 as an example of the image processing apparatus according to the present embodiment includes the scanner 400 (illustrated in FIG. 2) to read a document and generate input image data D1 (first image data) of the document, the digit separator detection unit 705 (illustrated in FIG. 3), and the digit separator removal unit 706 (illustrated in FIG. 3). The digit separator detection unit 705 detects a digit separator line separately from other ruled lines in the input image data D1 (or the corrected image data D2) of the document read by the scanner 400. The digit separator line is a vertical ruled line that divides a numerical value by one digit or three digits. The digit separator removal unit 706 removes the digit separator line detected by the digit separator detection unit 705 from the input image data D1 (or the corrected image data D2) of the document.

With this configuration, the image processing apparatus can detect digit separator lines on a business form separately from other ruled lines, and remove only the digit separator lines even when the digit separator lines are printed in a non-dropout color. The non-dropout color is a color not removed by a dropout color function. Accordingly, in a series of automatic processing including extraction of money amounts in a business form and character recognition in the extracted region performed in OCR, ruled lines other than digit separator lines are not removed in the former processing to increase the accuracy of the extraction, and the digit separator lines are removed in the latter processing to increase the accuracy of recognition. Thus, the accuracy of the entire process increases. As a result, the image forming apparatus 20 of the present embodiment increases the accuracy of the automatic process performed in OCR.

In the image forming apparatus 20 of the present embodiment, the digit separator detection unit 705 detects the digit separator lines based on the respective detection results of the table detection unit 702 that detects the table region from the input image data D1 (or the corrected image data D2) of the document read by the scanner 400, the column detection unit 703 that detects the column region in the table region, and the ruled-line detection unit 704 that detects the ruled lines.

By performing the detection of a column region and the detection of ruled lines in the column region to detect digit separator lines instead of directly detecting digit separator lines, this configuration can reduce the parameters of a learned model used in the inference unit 733 and the amount of calculation while coping with various table images and various digit separator lines.

In the image forming apparatus 20 according to the present embodiment, the column detection unit 703 inputs to the learned model the table image data D4, which represents the table region detected and extracted by the table detection unit 702 from the input image data D1 (or the corrected image data D2) of the document, to infer the column region.

In this configuration, use of a learned model generated in advance by machine learning to detect a column enables highly accurate detection of various kinds of table images and enables highly accurate detection and removal of various kinds of digit separator lines.

In the image forming apparatus 20 of the present embodiment, the learned model used by the inference unit 733 of the column detection unit 703 has learned from the teacher data TD in which a region including a digit separator line is labeled as a column region.

As a result, a learned model that performs column detection suitably for detecting and removing digit separator lines can be generated.

In the image forming apparatus 20 according to the present embodiment, the digit separator detection unit 705 detects digit separator lines in the binary image data D3 obtained by monochromatizing the input image data D1. This configuration reduces the amount of information input to and output from the learned model used by the inference unit 733 of the column detection unit 703, and the learned model can be lightweight.

In the image forming apparatus 20 of the present embodiment, on and off of the digit separator removal unit 706 can be switched, that is, whether to execute the removal of digit separator lines can be switched. With this configuration, in a case where the money amount overlaps the digit separator line, loss of characters representing the money amount can be prevented by turning off the digit-separator line removal.

The image processing system 100 according to the present embodiment includes the image forming apparatus 20 as an image processing apparatus, and transmits the digit-separator-removed image data D8 from which the digit separator lines have been removed by the image forming apparatus 20 to the outside via the network N or the networks N1 and N2 as illustrated in FIGS. 1B and 1C.

With this configuration, the digit-separator-removed image data D8 is transmitted to an external device such as the PC 40 as illustrated in FIG. 1B, and the PC 40 performs OCR on the digit-separator-removed image data D8 using OCR software to increase the OCR accuracy of numerals representing an amount in the region of the business form where the digit separator lines were present in the input image data D1. Similarly, as illustrated in FIG. 1C, the digit-separator-removed image data D8 may be transmitted to an external storage device 60 (an external device) and stored therein to allow an external device such as the PC 40 connected to the storage device 60 to perform OCR on the digit-separator-removed image data D8 using OCR software. Accordingly, even when the digit-separator-removed image data D8 is transmitted to the external storage device 60, the OCR accuracy of numerals each representing an amount in the region of the business form where the digit separator line was originally present in the input image data D1 can be increased.

In one aspect, the image forming apparatus 20 as the image processing apparatus according to the present embodiment includes the scanner 400 to read a document to generate the input image data D1 of the document, and an output unit to output the digit-separator-removed image data D8 in which the digit separator line is removed from the input image data D1 (or the corrected image data D2) of the document by using the learned model. The functions of the output unit correspond to, for example, those provided by the functional blocks from the binarization unit 701 to the digit separator removal unit 706 illustrated in FIG. 3, and the hardware of the output unit corresponds to, for example, the controller CPU 310 and the network I/F 600 illustrated in FIG. 2.

In this configuration, use of a learned model generated in advance by machine learning enables highly accurate detection and removal of various kinds of digit separator lines, and high-quality digit-separator-removed image data D8 can be output. The use of high-quality digit-separator-removed image data D8 can increase the accuracy of the automatic processing in OCR.

FIG. 10 is a flowchart of an image processing process performed by the image forming apparatus 20 according to the present embodiment.

In step S11, the scanner 400 reads an image from, for example, a paper document placed on a reading table of the image forming apparatus 20 and generates input image data D1 representing the content of the paper document such as a business form. In the present embodiment, the document serving as an object from which an image subject to image processing is read is a document in which some amount is written, such as an invoice illustrated in FIG. 6A.

In step S12, the scanner 400 performs top-bottom correction of the input image data D1 generated in step S11. In the top-bottom correction, the input image data D1 is corrected so that the top and bottom of the document, which is the source of the input image data D1, are oriented in the correct directions. In this step, the input image data D1 may be subjected to image processing to correct image deterioration during reading (e.g., skew correction) or optional processing (e.g., OCR). The scanner 400 outputs the corrected image data D2, which is the result of the process of step S12, to the binarization unit 701 of the image forming apparatus 20.

In step S13, the binarization unit 701 binarizes the corrected image data D2 generated by the image processing in step S12. For example, the corrected image data D2 input to the binarization unit 701 is an RGB image data. The binarization unit 701 converts the RGB image data into grayscale image data and further converts the grayscale image data into the binary image data D3. In the present embodiment, the binary image data D3 to be processed is binary image data of a document containing numerals representing some amount, such as an invoice illustrated in FIG. 6A. The binarization unit 701 outputs the converted binary image data D3 to the table detection unit 702, the column detection unit 703, the ruled-line detection unit 704, and the digit separator removal unit 706 of the image forming apparatus 20.

In step S14, the table detection unit 702 detects a table region from the binary image data D3 converted in step S13. The table region is a portion representing a table containing numerals representing some amount in the binary image data D3, such as a table of items of an invoice illustrated in FIG. 6B. Table regions are recognized by, for example, the method described in Japanese Unexamined Patent Application Publication No. 2000-082110. The table detection unit 702 outputs the table image data D4 including the table region detected from the binary image data D3 to the column detection unit 703.

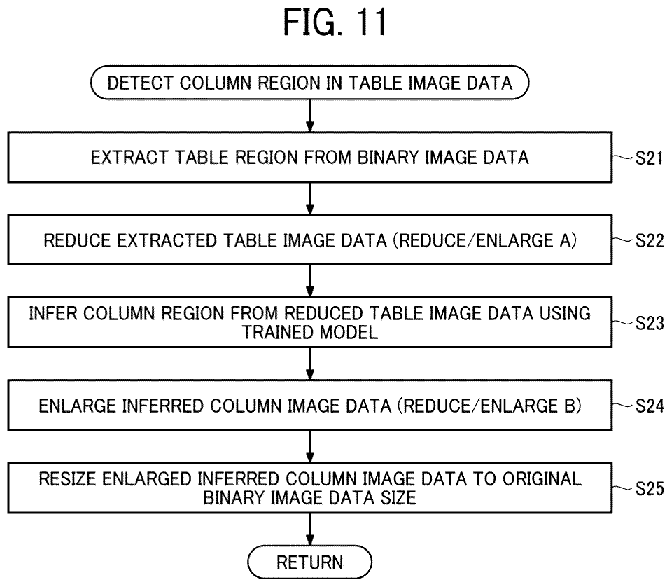

In step S15, the column detection unit 703 detects a column region from the table image data D4 detected in step S14. The column region is a portion containing a numerical value representing an amount in the table region of the image data, such as a unit price or an amount of money for each item, or a total amount to be charged in the table of the invoice illustrated in FIGS. 6C and 6D. The column detection unit 703 performs the subroutine processing illustrated in FIG. 11. FIG. 11 is a flowchart of a subroutine process performed by the column detection unit 703 in step S15 of FIG. 10.

In step S21, the table extraction unit 731 extracts a table region from the binary image data D3 as illustrated in FIG. 6B. The table extraction unit 731 outputs the table image data D4 including the extracted table region to the first reduce/enlarge unit 732.

In step S22, the first reduce/enlarge unit 732 reduces (scaling A) the table image data D4 extracted in step S21 as illustrated in FIG. 6C. The first reduce/enlarge unit 732 outputs the scaled table image data D41 to the inference unit 733.

In step S23, the inference unit 733 infers a column region from the scaled table image data D41 reduced in step S22 as illustrated in FIG. 6D using the learned model. The inference unit 733 outputs the inferred column image data D51 including the column region based on the output from the learned model to the second reduce/enlarge unit 734.

In step S24, the second reduce/enlarge unit 734 enlarges the inferred column image data D51 after the column region is inferred in step S23 as illustrated in FIG. 6E (scaling B). The second reduce/enlarge unit 734 outputs the inferred column image data D52 after scaling to the image resizing unit 735.

In step S25, the image resizing unit 735 resizes the inferred column image data D52 after scaling, which has been scaled in step S24, into the size of the original binary image data D3, as illustrated in FIG. 6F. The image resizing unit 735 outputs the inference result image data D53 as the column image data D5 to the digit separator detection unit 705. When the process of step S25 is completed, the process returns to the main process of FIG. 10.

Referring back to FIG. 10, in step S16, the ruled-line detection unit 704 extracts ruled lines from the binary image S13 converted in step D3. In this step, the ruled-line detection unit 704 extracts two types of ruled lines, that is, vertical ruled lines and horizontal ruled lines. Rules lines are recognized by, for example, the method described in Japanese Unexamined Patent Application Publication No. 2000-082110. The ruled-line detection unit 704 outputs the ruled-line image data D6 (the horizontal ruled-line image data D61 and the vertical ruled-line image data D62) detected from the binary image data D3 to the digit separator detection unit 705.

In step S17, the digit separator detection unit 705 detects a region with a digit separator line from the binary image data D3. Specifically, the digit separator detection unit 705 detects a region that has been detected as a column region by the column detection unit 703 in step S15 and has been detected as a vertical ruled line by the ruled-line detection unit 704 in step S16. Digit separator lines are vertical line that divide a numerical value representing an amount by a predetermined number of digits in a column region containing the numerals representing the amount, as illustrated in FIG. 4(a). Digit separator lines are indicated by broken lines in FIG. 4(a). The digit separator detection unit 705 outputs the digit separator line image data D7 to the digit separator removal unit 706.

In step S18, the digit separator removal unit 706 removes the digit separator lines detected in step S17 from the binary image data D3 converted in step S13. For example, the digit separator removal unit 706 replaces the black pixels in the binary image data D3 corresponding to the region of the digit separator line image data D7 detected by the digit separator detection unit 705 with white pixels to remove the digit separator lines from the binary image data D3. The digit separator removal unit 706 outputs the digit-separator-removed image data D8 from which the digit separator lines are removed. When the operation in step S18 is completed, the process ends.

As described above with reference to FIGS. 10 and 11, the image processing method according to the present embodiment includes the step S11 (reading) in which the scanner 400 of the image forming apparatus 20 reads a document, the step S17 (detecting digit separator lines) in which the digit separator detection unit 705 of the image forming apparatus 20 detects digit separator lines that are vertical lines dividing numerals representing an amount by one digit or three digits from the input image data D1 (more specifically, the corrected image data D2) of the document read in the step S11, and the step S18 (removing the digit separator lines) in which the digit separator removal unit 706 of the image forming apparatus 20 removes the digit separator lines detected in the step S17 from the input image data D1 (more specifically, the corrected image data D2) of the document read in the step S11.

With this configuration, digit separator lines on a business form can be detected and removed separately from other ruled lines even when the digit separator lines are printed in a non-dropout color that is not removed by a dropout color function. Accordingly, in a series of automatic processing including extraction of money amounts in a business form and character recognition in the extracted region performed in OCR, ruled lines other than digit separator lines are not removed in the former processing to increase the accuracy of the extraction, and the digit separator lines are removed in the latter processing to increase the accuracy of recognition. Thus, the accuracy of the entire process increases. As a result, the image processing method according to the present embodiment increases the accuracy of the automatic process performed in OCR.

The embodiments of the present disclosure are described above with reference to specific examples. However, the present disclosure is not limited to the specific examples described above. Those skilled in the art may add design modifications to these specific examples, and such modified configurations having the features of the present disclosure are within the scope of the present disclosure. The elements in the specific examples described above, as well as the arrangement, conditions, and shapes of those elements are not limited to those described or illustrated, but can be changed as appropriate. The elements in the specific examples described above can be appropriately combined as long as there is no technical contradiction.

Aspects of the present disclosure are, for example, as follows.

In Aspect 1, an image processing apparatus includes a scanner to read a document and generates first image data of the document, a digit separator detection unit to detect a digit separator line separately from other ruled lines in the first image data, and a digit separator removal unit to remove the digit separator line from the first image data of the document.

The digit separator line is a vertical ruled line that divides a numerical value by one digit or three digits.

In Aspect 2, in the image processing apparatus according to Aspect 1, the digit separator detection unit detects the digit separator line based on respective detection results generated by a table detection unit to detect a table region from the first image data of the document read by the scanner, a column detection unit to detect a column region in the table region, and a ruled-line detection unit to detect the ruled line.

In Aspect 3, in the image processing apparatus According to Aspect 2, the column detection unit inputs, into a learned model, image data of the table region detected by the table detection unit and extracted from the first image data of the document to infer the column region.

In Aspect 4, in the image processing apparatus according to Aspect 3, the learned model has learned from teacher data in which a region including a digit separator line is set as a column region.

In Aspect 5, in the image processing apparatus according to any one of Aspects 1 to 4, the digit separator line detection unit detects the digit separator line in the first image data that has been monochromatized.

In Aspect 6, in the image processing apparatus according to any one of Aspects 1 to 5, the digit separator removal unit switches whether to perform removal of the digit separator line.

In Aspect 7, an image processing system includes the image processing apparatus according to any one of Aspects 1 to 6, and transmits second image data obtained by removing the digit separator lines from the first image data via a network to an external device.

In Aspect 8, an image processing method includes a step of reading a document to generate first image data; a step of detecting a digit separator line, which is a vertical line dividing a numerical value by one digit or three digits, separately from another ruled line in the first image data of the document; and a step of removing the digit separator line from the first image data of the document.

In Aspect 9, an image processing apparatus includes a scanner to read a document and generate first image data of the document; and an output unit to output second image data obtained by removing a digit separator line from the first image data of the document using a learned model.

In Aspect 10, in the image processing apparatus according to Aspect 9, the learned model has learned from teacher data including digit separator lines.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a compact disc read-only memory (CD-ROM) or digital versatile disc (DVD), and/or the memory of an FPGA or ASIC.

1. An image processing apparatus comprising:
a scanner to read a document and generate first image data of the document; and
circuitry configured to:
detect a digit separator line in the first image data separately from another ruled line, the digit separator line being a vertical ruled line that divides a numerical value by one digit or three digits; and
remove the digit separator line from the first image data.

2. The image processing apparatus according to claim 1,
wherein the circuitry is configured to:
detect a table region in the first image data;
detect a column region in the table region;
detect said another ruled line; and
detect the digit separator line based on detection results of the table region, the column region, and said another ruled line.

3. The image processing apparatus according to claim 2,
wherein the circuitry is configured to input, into a learned model, image data of the table region extracted from the first image data of the document to infer the column region.

4. The image processing apparatus according to claim 3,
wherein the learned model has learned from teacher data in which a region including a digit separator line is set as a column region.

5. The image processing apparatus according to claim 3,
wherein the circuitry is configured to:
monochromatize the first image data; and
detect the digit separator line in the monochromatized first image data.

6. The image processing apparatus according to claim 1,
wherein the circuitry is configured to switch whether to remove the digit separator line.

7. The image processing apparatus according to claim 1,
wherein the circuitry is further configured to transmit second image data via a network to an external device external to the image processing apparatus, the second image data being obtained by removing the digit separator line from the first image data.

8. An image processing apparatus comprising:
a scanner to read a document and generate first image data of the document; and
circuitry configured to output second image data obtained by removing a digit separator line from the first image data using a learned model.

9. The image processing apparatus according to claim 8,
wherein the learned model has learned from teacher data including a digit separator line.

10. An image processing method comprising:
reading a document to generate first image data of the document;
detecting a digit separator line in the first image data separately from another ruled line, the digit separator line being a vertical ruled line that divides a numerical value by one digit or three digits; and
removing the digit separator line from the first image data.

11. A non-transitory recording medium storing a plurality of program codes which, when executed by one or more processors, causes the one or more processors to perform a method, the method comprising:
reading a document to generate first image data of the document;
detecting a digit separator line in the first image data separately from another ruled line, the digit separator line being a vertical ruled line that divides a numerical value by one digit or three digits; and
removing the digit separator line from the first image data.
